(19) United States
(12) Patent Application Publication
(10) Pub. No.: US 2015/0264966 A1
(43) Pub. Date: Sep. 24, 2015

(54) Malanga root baby food composition

(71) Applicant: Liz Hernandez, Houston, TX (US)

(72) Inventor: Liz Hernandez, Houston, TX (US)

(21) Appl. No.: 14/285,600

(22) Filed: May 22, 2014

Related U.S. Application Data
(60) Provisional application No. 61/820,246, filed on May 7, 2013.

(51) Int. Cl. A23L 1/29; A23L 1/212

(52) U.S. Cl. CPC A23L 1/296; A23L 1/2128; A23V 2002/00

(57) ABSTRACT

A malanga root composition for baby food and method of preparation are disclosed. The malanga root is peeled, boiled, pureed, and packaged alone or mixed with other ingredients to provide a nutritionally balanced and complete diet. Malanga root has been proven to be hypoallergenic, and an effective home remedy for acid reflux disease and other digestive disorders.

### CROSS-REFERENCE TO RELATED APPLICATIONS

This Application claims the benefit of U.S. Provisional Application No. 61/820,246, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to baby food compositions, and in particular to a malanga root baby food composition. Parents of infants are frequently faced with food allergies, acid reflux disease, and other digestive disorders suffered by their infants. The proper food selection could resolve these disorders without the cost and inconvenience of medical intervention, or the use of pharmaceutical remedies which may have side effects. In Cuba and South American countries, malanga root has been used as a baby food for generations. It has been proven to be hypoallergenic, and an effective home remedy for acid reflux disease and other digestive disorders. However, it has never been packaged and marketed in a prepared form, and is not readily available to consumers. Alone or mixed with other ingredients to provide a nutritionally balanced diet, malanga root could provide an effective non-medical solution for millions of American parents whose infants have digestive disorders.

### SUMMARY OF THE INVENTION

Accordingly, the invention is directed to a malanga root composition for baby food. The malanga root is peeled, boiled, pureed, and packaged alone or mixed with other ingredients to provide a nutritionally balanced and complete diet. Malanga root has been proven to be hypoallergenic, and an effective home remedy for acid reflux disease and other digestive disorders.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

No drawing is provided for the disclosed invention because a drawing is not necessary for the understanding of the invention under 35 U.S.C. §113, 37 C.F.R. §1.81(a), and MPEP §608.02 (III) (A), (B).

### DETAILED DESCRIPTION OF THE INVENTION

Referring now to the invention in more detail, the invention is directed to a malanga root composition for baby food. The malanga root is peeled, boiled, pureed, and packaged alone or mixed with other ingredients to provide a nutritionally balanced and complete diet. Malanga root has been proven to be hypoallergenic, and an effective home remedy for acid reflux disease and other digestive disorders. Malanga root is gluten free, is high in fiber, and requires smaller amounts of stomach acids to digest, aiding in relief of side effects experienced from digestive disorders.

Malanga root has been previously known as a suitable baby food, however it has not been produced as a packaged product in prepared form. It is suitable as a baby's first food, to prepare the baby's delicate digestive tract for Stage 1 foods such as sweet potatoes or carrots. It is also suitable as a treatment and food for older patients with acid reflux disease and other minor digestive disorders.

The malanga root is peeled, boiled, pureed to a consistency suitable for spoon-feeding to a four-month-old infant, then packaged in a foil pouch manufactured from aluminum or other flexible material or tempered glass sealed with an aluminum or steel lid. The puree may be made with the same water that was used to boil the malanga root. Before packaging, the malanga root puree may be mixed with small amounts of other carefully selected whole foods, such as carrot, sweet potato, or meat such as chicken, pork or beef, to provide a more nutritionally balanced and complete diet. To use the product, the user may mix it with water, formula or other preferred liquid, to the desired consistency, and spoon feed it to the infant or older patient.

For four-month-old infants (generally not able to eat any solid foods including stage one baby foods), a pure malanga root puree is provided to prepare the infant's digestive system for other solid foods. For infants five to six months old (generally able to eat stage one baby foods), the malanga root is pureed with fruits or vegetables, such as butternut or other squash, sweet potatoes, carrots, sweet peas, strawberries, pears, apples, and green beans. For infants six to nine months old, the malanga root is pureed with said fruits or vegetables, as well as meat such as chicken, pork, turkey or beef.

Components and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A method of preparing a food composition comprising peeling, boiling in a quantity of water, removing from said quantity of water, and pureeing a quantity of malanga root to a mixture of spoon-feeding consistency, whereby a food composition suitable for infants four months old otherwise unable to be fed solids is provided.

2. The method of claim 1 further comprising packaging said mixture of spoon-feeding consistency in a foil pouch.

3. The method of claim 1 further comprising packaging said mixture of spoon-feeding consistency in a tempered glass container, said tempered glass container being sealed with a lid.

4. The method of claim 1 further comprising adding a portion of said quantity of water to said quantity of malanga root prior to pureeing.

5. The method of claim 2 further comprising adding a portion of said quantity of water to said quantity of malanga root prior to pureeing.

6. The method of claim 3 further comprising adding a portion of said quantity of water to said quantity of malanga root prior to pureeing.

7. The method of claim 1 further comprising, after pureeing, adding to said quantity of malanga root a quantity of one or more pureed foods such that said mixture of spoon-feeding consistency is substantially composed of both said quantity of malanga root and said quantity of one or more pureed foods.

8. The method of claim 7 wherein said quantity of one or more pureed foods is selected from the group of carrot, sweet potato, squash, butternut squash, sweet peas, strawberries, pears, apples, green beans, chicken, pork, turkey, or beef).

9. The method of claim 4 further comprising, after pureeing, adding to said quantity of malanga root a quantity of one or more pureed foods such that said mixture of spoon-feeding consistency is substantially composed of both said quantity of malanga root and said quantity of one or more pureed foods.

10. The method of claim 10 wherein said quantity of one or more pureed foods is selected from the group of carrot, sweet potato, squash, butternut squash, sweet peas, strawberries, pears, apples, green beans, chicken, pork, turkey, or beef).

11. The method of claim 5 further comprising, after pureeing, adding to said quantity of malanga root a quantity of one or more pureed foods such that said mixture of spoon-feeding consistency is substantially composed of both said quantity of malanga root and said quantity of one or more pureed foods.

12. The method of claim 11 wherein said quantity of one or more pureed foods is selected from the group of carrot, sweet potato, squash, butternut squash, sweet peas, strawberries, pears, apples, green beans, chicken, pork, turkey, or beef).

13. The method of claim 6 further comprising, after pureeing, adding to said quantity of malanga root a quantity of one or more pureed foods such that said mixture of spoon-feeding consistency is substantially composed of both said quantity of malanga root and said quantity of one or more pureed foods.

14. The method of claim 13 wherein said quantity of one or more pureed foods is selected from the group of carrot, sweet potato, squash, butternut squash, sweet peas, strawberries, pears, apples, green beans, chicken, pork, turkey, or beef).

15. A method of use of the product of the method of claim 1 comprising feeding said mixture of spoon-feeding consistency to an infant at a development stage not yet able to eat other solids.

16. A method of use of the product of the method of claim 1 comprising treating a digestive disorder in a human by feeding said mixture of spoon-feeding consistency to said human.

17. A method of use of the product of the method of claim 7 comprising feeding said mixture to an infant at a development stage sufficient for eating stage one baby foods.

18. A method of use of the product of the method of claim 8 comprising feeding said mixture to an infant at a development stage sufficient for eating stage one baby foods.

19. A method of use of the product of the method of claim 4 comprising feeding said mixture of spoon-feeding consistency to an infant at a development stage not yet able to eat other solids.

20. A method of use of the product of the method of claim 41 comprising treating a digestive disorder in a human by feeding said mixture of spoon-feeding consistency to said human.
